(19) United States
(12) Patent Application Publication
(10) Pub. No.: US 2010/0308780 A1
(43) Pub. Date: Dec. 9, 2010

(54) PHASE-CONTROLLED NON-ZERO-CROSS PHOTOTRIAC WITH ISOLATED FEEDBACK

(75) Inventors: Weiguang Qiu, Fremont, CA (US); Robert Gee, Sunnyvale, CA (US)

Correspondence Address: VOLPE AND KOENIG, P.C., UNITED PLAZA, 30 SOUTH 17TH STREET, PHILADELPHIA, PA, 19103, US

(73) Assignee: VISHAY INFRARED COMPONENTS, INC., Santa Clara, CA (US)

(21) Appl. No.: 12/480,392

(22) Filed: Jun. 8, 2009

(51) Int. Cl. H02J 3/12

(52) U.S. Cl. 323/237

(57) ABSTRACT

An electronic component for providing optical isolation an electronic component package, a phototriac disposed within the electronic component package for providing the optical isolation, and a reverse zero-cross feedback channel integrated into the electronic component package to thereby provide zero-cross detection. The electronic component may be in a circuit which includes a phase control circuit. A method of driving an AC load and providing zero-cross detection using a single electronic component includes providing an electronic component having an electronic component package, a phototriac disposed within the electronic component package, and a reverse zero-cross feedback channel integrated into the electronic component package to thereby provide for zero-cross detection. The method further includes placing the electronic component within a circuit.

### FIELD OF THE INVENTION

The present invention relates to electronic components, more particularly, the present invention relates to a phase-controlled non-zero-cross phototriac with isolated feedback.

### BACKGROUND

Phototriac couplers are used in numerous applications, including in applications which are powered by the AC mains network and AC voltage loads are to be controlled through switching. Phototriac couplers may be used to galvanically isolate the control side of a circuit and a load side of a circuit. Thus, phototriac couplers are useful in various types of applications, including the control of motors.

Both zero-cross and non-zero-cross phototriac couplers are available. In a zero-cross type phototriac, the output will only switch to an on-state if the load voltage is below the zero-cross voltage value. In a non-zero-cross type phototriac coupler, the switching to the on-state is immediate. In a non-zero-cross type phototriac coupler, the root mean square may be controlled by phase delays.

What is needed is a means to provide isolated feedback from a load side of a circuit which uses a phototriac coupler to the control side of the circuit in a non-zero-cross phototriac.

Therefore, it is a primary object, feature, or advantage of the present invention to improve over the state of the art.

It is a further object, feature, or advantage of the present invention to provide a phase-controlled non-zero-cross phototriac with isolated feedback.

One or more of these and/or other objects, features, or advantages of the present invention will become apparent from the specification and claims that follow.

### SUMMARY

According to one aspect of the present invention, an electronic component for providing optical isolation is provided. The electronic component includes an electronic component package, a phototriac disposed within the electronic component package for providing the optical isolation, and a reverse zero-cross feedback channel integrated into the electronic component package to thereby provide zero-cross detection.

According to another aspect of the present invention, an electrical circuit is provided. The electrical circuit includes an electronic component having an electronic component package, a phototriac disposed within the electronic component package for providing optical isolation, and a reverse zero-cross feedback channel integrated into the electronic component package to thereby provide for zero-cross detection. The electrical circuit also includes a phase control circuit electrically connected to inputs of the reverse zero-cross feedback channel.

According to another aspect of the present invention, a method of driving an AC load and providing zero-cross detection using a single electronic component is provided. The method includes providing an electronic component having an electronic component package, a phototriac disposed within the electronic component package, and a reverse zero-cross feedback channel integrated into the electronic component package to thereby provide for zero-cross detection. The method further includes placing the electronic component within a circuit.

### BRIEF DESCRIPTION OF THE DRAWINGS

FIG. 1 is a schematic illustrating a prior art circuit.

FIG. 2 is a schematic illustrating a circuit according to one embodiment of the present invention.

FIG. 3 is a schematic illustrating one example of a phase control circuit.

### DETAILED DESCRIPTION OF THE PREFERRED EMBODIMENT

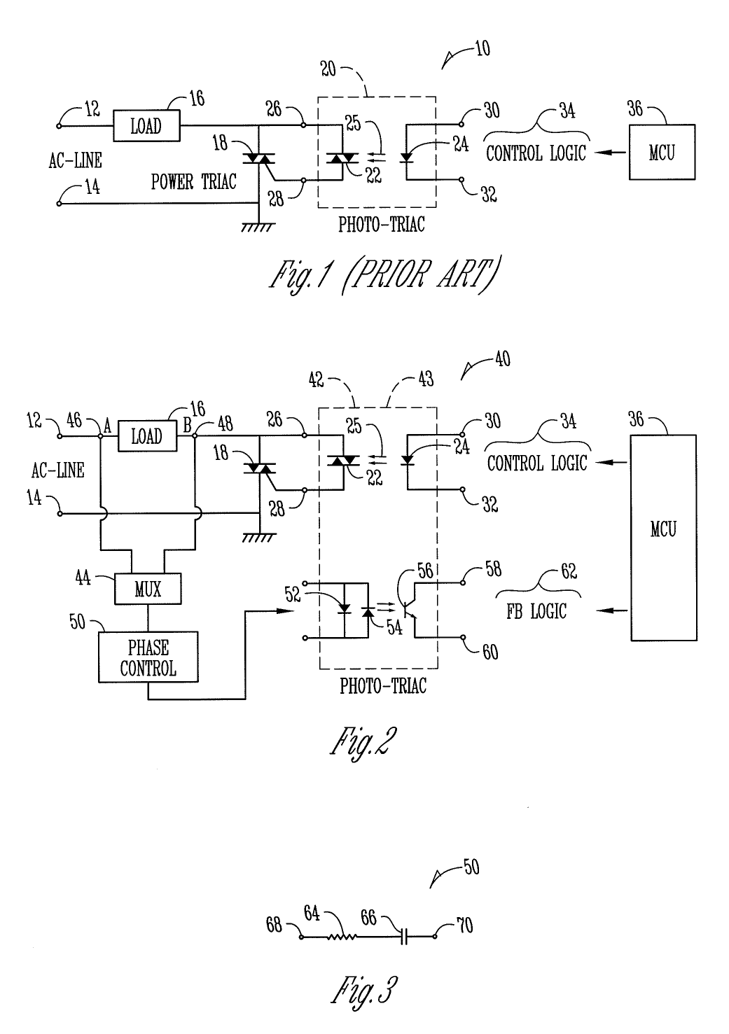

FIG. 1 illustrates one example of a prior art circuit 10. In the circuit 10, a phototriac component 20 is used to provide isolated control of a load 16. In the circuit 10, a microcontroller (MCU) 36 may drive control logic 34 to provide a control signal at inputs 30, 32 of the phototriac 20. An optical signal 25 is generated by an LED 24, to control the phototriac 22. Outputs 26, 28 from the phototriac 20 are electrically connected to a power triac 18 which is connected between the load 16 and a ground 14 of an AC voltage source. A terminal 12 associated with an AC voltage source is also electrically connected to the load 16. In operation, the microcontroller 36 sends a signal from the low voltage control side to control power delivered to the load 16 on the high voltage load side.

FIG. 2 illustrates one embodiment of a circuit 40 of the present invention. In FIG. 2 an electronic component 42 in integrated circuit form is shown which includes both a phototriac or optotriac 22 as well as a reverse zero-cross feedback channel integrated into the electronic component package 43 to thereby provide zero-cross detection. The electronic component package 43 may be of various sizes or types such as generally associated with electronic component packages in the industry. Thus, in the circuit 40, the microcontroller 36 both controls switching of the load 16 as well as receives feedback from the load side of the circuit.

To provide feedback, an optional multiplexer 44 is shown which is electrically connected across the load 16 and to a phase control circuit 50. The phase control circuit 50 is electrically connected to parallel LEDs 52, 54 which are are configured in opposite directions. An opto-receiver 56 is shown with outputs 58, 60 from the electronic component 42 which may be electrically connected to feedback logic and ultimately to the microcontroller 36. As shown, the microcontroller 36 may control a triac over a first optically isolated non-zero-cross channel and receive zero-cross detection feedback over an optically isolated second channel in the opposite direction. The zero-cross detection feedback allows the microcontroller 36 to alter the power delivered to the load 16, based on the zero-cross detection feedback.

The multiplexer 44 is optional when only a signal at node A 46 or only a signal at node B 48 is to be determined for feedback purposes. If however, signals at both node A 46 and node B 48 are to be determined, then the multiplexer should be used.

FIG. 3 illustrates one example of the phase control circuit 50. As shown in FIG. 3, a resistor 64 and capacitor 66 are placed in series between nodes 68, 70 to form an RC network. Of course, the present invention contemplates that the phase control circuit 50 may be formed in other ways. The phase control circuit 50 is used to block the high AC 30 voltage to the zero-cross direction as well as to provide a phase shift of the zero-cross detection.

Therefore, a phase-controlled non-zero-cross phototriac with isolated feedback has been disclosed. In addition, a circuit has been disclosed for use with the phase-controlled non-zero-cross phototriac has also been disclosed. The present invention is not to be limited to specific embodiments herein, as modifications, options, and alternatives, are intended to fall within the spirit and scope of the claimed invention.

What is claimed is:

1. An electronic component for providing optical isolation, the electronic component comprising:
an electronic component package;
a phototriac disposed within the electronic component package for providing the optical isolation; and
a reverse zero-cross feedback channel integrated into the electronic component package to thereby provide zero-cross detection.

2. The electronic component of claim 1 wherein the reverse zero-cross feedback channel is configured to provide feedback from a load side of a circuit to an isolated control side of the circuit.

3. An electrical circuit comprising:
an electronic component comprising:
(a) an electronic component package,
(b) a phototriac disposed within the electronic component package for providing optical isolation, and
(c) a reverse zero-cross feedback channel integrated into the electronic component package to thereby provide for zero-cross detection; and
a phase control circuit electrically connected to inputs of the reverse zero-cross feedback channel.

4. The electrical circuit of claim 3 wherein the phase control circuit comprises an RC network.

5. The electrical circuit of claim 3 wherein the phase control circuit is configured for blocking high AC-voltage to the reverse, zero-cross feedback channel.

6. The electrical circuit of claim 5 wherein the phase control circuit is configured to phase shift.

7. The electrical circuit of claim 3 further comprising a multiplexer electrically connected to the phase control circuit.

8. The electrical circuit of claim 3 further comprising an AC-driven load electrically connected to the phototriac and the phase control circuit.

9. The electrical circuit of claim 3 wherein the AC-driven load comprises a motor.

10. The electrical circuit of claim 3 further comprising a microcontroller electrically connected to the electronic component to provide control and receive feedback.

11. A method of driving an AC load and providing zero-cross detection using a single electronic component, the method comprising:
providing an electronic component comprising:
(a) an electronic component package,
(b) a phototriac disposed within the electronic component package, and
(c) a reverse zero-cross feedback channel integrated into the electronic component package to thereby provide for zero-cross detection; and
placing the electronic component within a circuit.

12. The method of claim 11 wherein the circuit further comprises a phase control circuit electrically connected to inputs of the reverse zero-cross feedback channel.
